(19) United States
(12) Patent Application Publication
(10) Pub. No.: US 2014/0184394 A1
(43) Pub. Date: Jul. 3, 2014

(54) COMMUNICATION DEVICE AND METHOD FOR CONTROLLING ELECTRONIC DEVICE

(71) Applicants: HON HAI PRECISION INDUSTRY CO., LTD., New Taipei (TW); HONG FU JIN PRECISION INDUSTRY (ShenZhen) CO.,LTD., Shenzhen (CN)

(72) Inventors: JIE LIU, Shenzhen (CN); XIAO-JUN ZHOU, Shenzhen (CN)

(73) Assignees: HONG FU JIN PRECISION INDUSTRY (ShenZhen) CO.,LTD., Shenzhen (CN); HON HAI PRECISION INDUSTRY CO., LTD., New Taipei (TW)

(21) Appl. No.: 14/135,673

(22) Filed: Dec. 20, 2013

(30) Foreign Application Priority Data
Dec. 27, 2012 (CN) 2012105783460

(51) Int. Cl. G08C 19/16

(52) U.S. Cl. CPC G08C 19/16
USPC 340/12.22

(57) ABSTRACT

In a method of controlling locking or unlocking of an electronic device using a communication device, a control protocol between the communication device and the electronic device is established, and locking commands of the electronic device are preset. The locking commands are sent to the electronic device to lock the electronic device when a signal of locking the electronic device is received by the communication device, and an unlocking command is sent to the electronic device to unlock the electronic device when a signal of unlocking the electronic device is received by the communication device. Finally, the control protocol between the communication device and the electronic device is terminated.

### BACKGROUND

1. Technical Field

Embodiments of the present disclosure relate to device controlling technology, and more particularly, to electronic devices remote controlling method using a communication device.

2. Description of Related Art

Electronic devices, such as, smart phones, tablet personal computers, are popular. There are various functions installed in the electronic devices, such as video, games, instant messaging, and social networks. Thus, most people spend more and more time on the electronic devices, for example, when eating, when having a meeting, even when attending classes. How to “drag” people away from their electronic devices is a problem. Therefore, there is room for improvement in the art.

### BRIEF DESCRIPTION OF THE DRAWINGS

FIG. 1 is a block diagram of one embodiment of hardware configuration of an electronic device controlling system.

FIG. 2A and FIG. 2B are block diagrams of one embodiment of function modules of the electronic device controlling system.

FIG. 3 is a flowchart of one embodiment of an electronic device controlling method executed by a communication device.

FIG. 4 is a flowchart of one embodiment of an electronic device controlling method executed by one of one or more electronic devices.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processers. The modules described herein may be implemented as either software and/or hardware modules and may be stored in any type of non-transitory computer-readable storage medium or other computer storage device.

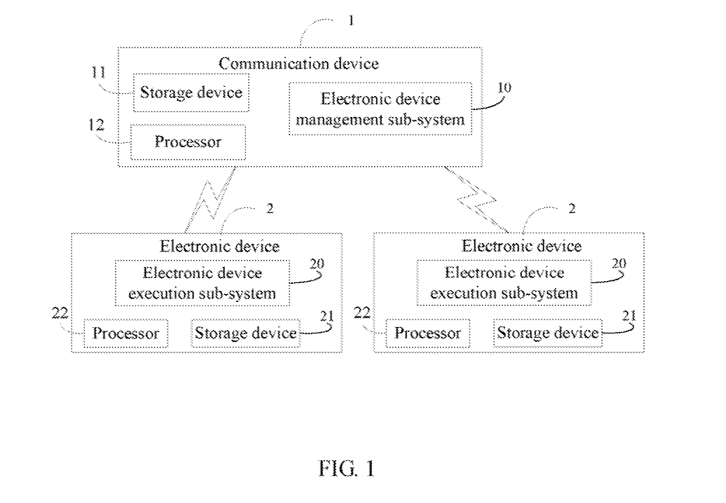

FIG. 1 is a block diagram of one embodiment of a hardware configuration of an electronic device controlling system. The hardware configuration of an electronic device controlling system comprises a communication device 1 and one or more electronic devices 2. The electronic device controlling system comprises an electronic device management sub-system 10 and an electronic device execution sub-system 20. The electronic device management sub-system 10 is installed in the communication device 1 and the electronic device execution sub-system 20 is installed in each of the one or more electronic devices 2. The communication device 1 and the one or more electronic devices 2 may be a smart phone, a portable computer, or a tablet personal computer, for example.

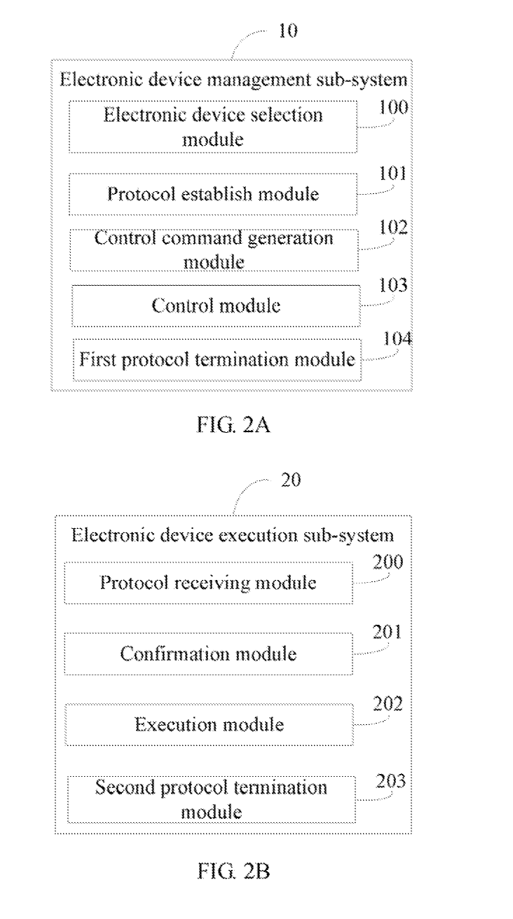

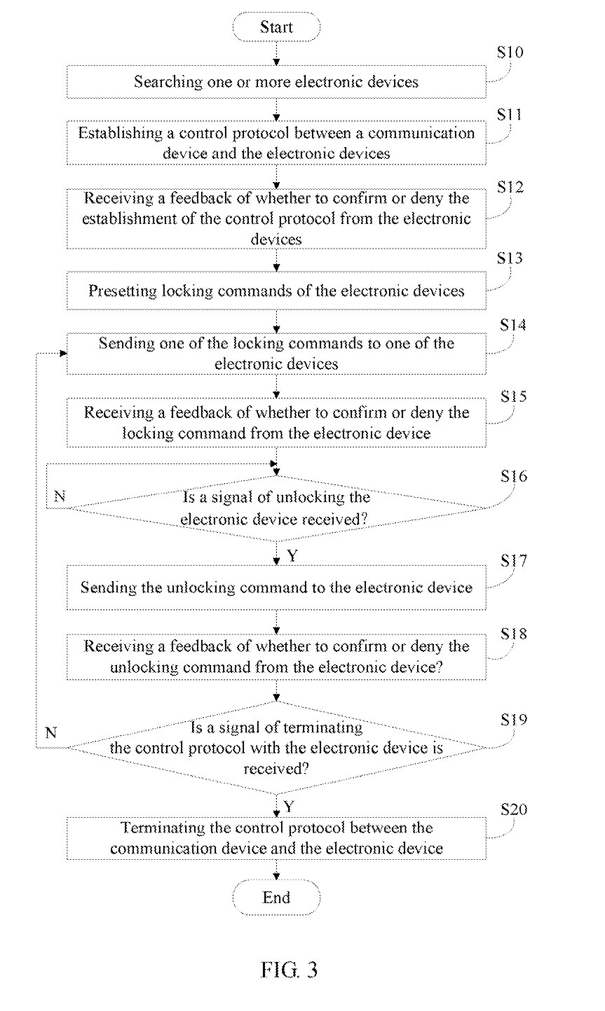

FIG. 2A is a block diagram of one embodiment of function modules of the electronic device management sub-system 10 of the electronic device controlling system. In the embodiment, the electronic device management sub-system 10 comprises an electronic device selection module 100, a protocol establish module 101, a control command generation module 102, a control module 103, and a first protocol termination module 104. The function module 100-104 comprises computerized codes in the form of one or more programs, which are stored in a storage device 11 of the communication device 1, and perform a function of sending control commands to lock or unlock the one or more electronic device 2 when executed by a processor 12 of the communication device 1. Details of the functions of the function modules 100-104 are described with reference to FIG. 3.

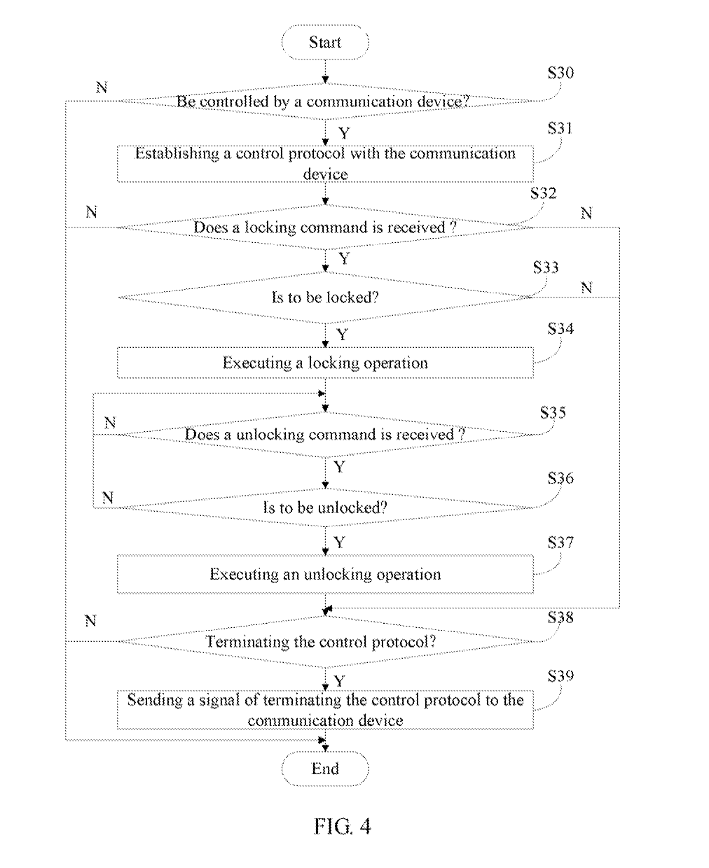

FIG. 2B is a block diagram of one embodiment of function modules of the electronic device execution sub-system 20 of the electronic device controlling system. In the embodiment, the electronic device execution sub-system 20 comprises a protocol receiving module 200, a confirmation module 201, an execution module 202, and a second protocol termination module 203. The function module 200-203 comprises computerized codes in the form of one or more programs, which are stored in a storage device 21 of each of the one or more electronic devices 2, and perform a function of executing locking or unlocking of applications or screen of each of the one or more electronic devices 2 according to the control commands sent by the communication device 1 when executed by a processor 22 of each of the one or more electronic devices 2. Details of the functions of the function modules 200-203 are described with reference to FIG. 4.

The storage device 11 of the communication device 1 and the storage device 21 of each of the one or more electronic devices 2 may include some type(s) of non-transitory computer-readable storage mediums, such as a hard disk drive, a compact disc, a digital video disc, or a tape drive.

FIG. 3 is a flowchart of one embodiment of an electronic device controlling method executed by the communication device 1. Depending on the embodiment, additional steps in FIG. 3 may be added, others removed, and the ordering of the steps may be changed.

In step S10, the electronic device selection module 100 of the communication device 1 searches one or more electronic devices 2 on a communication network. In one embodiment, the communication device 1 may join a local area network (LAN), and the electronic device selection module 100 can select the one or more electronic devices 2 from the LAN.

In step S11, the protocol establish module 101 establishes a control protocol between the communication device 1 and the one or more electronic devices 2. In one embodiment, the control protocol comprises identification information of the communication device 1 and identification information of the one or more electronic devices 2, and a communication mode between the communication device 1 and the one or more electronic devices 2. In one embodiment, the communication mode may be a WIFI mode, a BLUETOOTH mode, or a short message service (SMS) mode.

In step S12, the protocol establish module 101 receives a feedback of whether to confirm or deny the establishment of the control protocol from the one or more electronic devices 2.

In step S13, the control command generation module 102 presets locking commands of the one or more electronic devices 2 that have established the control protocol with the communication device 1. In one embodiment, each of the locking command comprises a locking target, a locking time period, and/or a command sending time. The locking target may be any application installed in the one or more electronic devices 2 or a screen of each of the one or more electronic devices 2. For example, one locking command may be as the following: locking the screens of all of the one or more electronic devices 2 for 45 minutes, and the command sending time is at 08:00 AM every Monday to Friday.

In step S14, the control module 103 sends one of the locking commands to one of the one or more electronic devices 2 when the command sending time of the locking command reaches.

In step S15, the control module 103 receives a feedback of whether to confirm or deny the locking command sent from the electronic device 2.

In step S16, the control module 103 determines if a signal of unlocking the electronic device 2 is received. In one embodiment, when a user of the communication device 1 selects a preset unlocking option, or the locking time period of the locking command expires or the electronic device 2 sends an unlocking request, a signal of unlocking the electronic device 2 can be received by the control module 103, then, step S17 is implemented. Otherwise, if no signal of unlocking the electronic device 2 is received, step S16 is repeated.

In step S17, the control module 103 sends the unlocking command to the electronic device 2.

In step S18, the control module 103 receives a feedback of whether to confirm or deny the unlocking command from the electronic device 2.

In step S19, the first protocol termination module 104 determines if a signal of terminating the control protocol with the electronic device 2 is received. The signal of terminating the control protocol may be received from the electronic device 2 or may be generated according to an operation made by the user of the communication device 1. Step S20 is implemented if the signal of terminating the control protocol is received. Otherwise, the process returns to step S14 if no signal of terminating the control protocol is received.

In step S20, the first protocol termination module 104 terminates the control protocol between the communication device 1 and the electronic device 2.

FIG. 4 is a flowchart of one embodiment of an electronic device controlling method executed by one of the one or more electronic devices 2. Depending on the embodiment, additional steps in FIG. 4 may be added, others removed, and the ordering of the steps may be changed.

In step S30, the protocol receiving module 200 determines if the electronic device 2 should be controlled by the communication device 1 when the communication device 1 establishes a control protocol with the electronic device 2. When a user of the electronic device 2 selects a preset confirmation option, the protocol receiving module 200 determines that the electronic device 2 should be controlled by the communication device 1, then step S31 is implemented. Otherwise, when the user of the electronic device 2 selects a preset deny option, the protocol receiving module 200 determines that the electronic device 2 should not be controlled by the communication device 1, then the procedure ends.

In step S31, the protocol receiving module 200 establishes the control protocol between the communication device 1 with the electronic device 2. In one embodiment, the control protocol comprises identification information of the communication device 1 and identification information of the one or more electronic devices 2, and a communication mode between the communication device 1 and the one or more electronic devices 2. In one embodiment, the communication mode may be a WIFI mode, a BLUETOOTH mode, or a short message service (SMS) mode.

In step S32, the confirmation module 201 determines if a locking command is received from the communication device 1. The locking command may comprise a locking target and a locking time period. The locking target may be any application installed in the electronic device 2 or a screen of the electronic device 2. For example, the locking command may be locking the screen of the electronic device 2 for 45 minutes. Step S33 is implemented if a locking command is received. Otherwise, step S38 is implemented if no locking command is received.

In step S33, the confirmation module 201 determines if the locking target is to be locked. When the user of the electronic device 2 selects a preset confirmation option, the confirmation module 201 determines that the locking target is to be locked, then, step S34 is implemented. Otherwise, when the user of the electronic device 2 selects a preset deny option, the confirmation module 201 determines that the locking target is not to be controlled, then step S38 is implemented.

In step S34, the execution module 202 executes a locking operation corresponding to the locking command. For example, the locking command is locking the screen of the electronic device 2, then the execution module 202 executes a locking operation on the screen, or the locking command is locking an application installed in the electronic device 2, then the execution module 202 executes a locking operation on the application.

In step S35, the confirmation module 201 determines if an unlocking command is received from the communication device 1. Step S36 is implemented if an unlocking command is received from the communication device 1. Otherwise, step S35 is repeated if no unlocking command is received from the communication device 1.

In step S36, the confirmation module 201 determines if the locking target is to be unlocked. When the user of the electronic device 2 selects a preset confirmation option, the confirmation module 201 determines that the locking target is to be unlocked, then step S37 is implemented. Otherwise, when the user of the electronic device 2 selects a preset deny option, the confirmation module 201 determines that the locking target is not to be unlocked, then step S35 is repeated.

In step S37, the execution module 202 executes an unlocking operation corresponding to the locking command. For example, the locking command is locking the screen of the electronic device 2, then the execution module 202 executes an unlocking operation on the screen, or the locking command is locking an application installed in the electronic device 2, then the execution module 202 executes an unlocking operation on the application.

In step S38, the second protocol termination module 23 determines if to terminate the control protocol with the communication device 1. In one embodiment, when the user of the electronic device 2 selects a preset termination option, the second protocol termination module 23 determines to terminate the control protocol with the communication device 1, then, step S39 is implemented. Otherwise, when the preset termination option is not selected, the process goes to step S32.

In step S39, the second protocol termination module 23 sends a terminating signal the control protocol to the communication device 1.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A communication device, that controls locking or unlocking of an electronic device, comprising:
a storage device;
at least one processor; and
one or more modules that are stored in the storage device and executed by the at least one processor, the one or more modules comprising instructions to:
establish a control protocol between the communication device and the electronic device;
preset locking commands of the electronic device;
send the locking commands to the electronic device to lock the electronic device when a signal of locking the electronic device is received;
send an unlocking command to the electronic device to unlock the electronic device when a signal of unlocking the electronic device is received; and
terminate the control protocol between the communication device and the electronic device.

2. The communication device according to claim 1, wherein the control protocol comprises identification information of the communication device and identification information of the electronic device, and a communication mode between the communication device and the electronic device.

3. The communication device according to claim 1, wherein the one or more modules comprises instructions to:
receive a feedback of whether to confirm or deny the establishment of the control protocol from the electronic device;
receive a feedback of whether to confirm or deny the locking command from the electronic device; and
receive a feedback of whether to confirm or deny the unlocking command from the electronic device.

4. The communication device according to claim 1, wherein each of the locking command comprises a locking target, a locking time period, and/or a command sending time.

5. The communication device according to claim 4, wherein the signal of locking the electronic device is received when the command sending time of the locking command reaches.

6. The communication device according to claim 4, wherein the signal of unlocking the electronic device is received when a preset unlocking option is selected, or when the locking time period of the locking command expires, or when the electronic device sends an unlocking request.

7. A method of controlling locking or unlocking of a electronic device using a communication device, comprising:
establishing a control protocol between the communication device and the electronic device;
presetting locking commands of the electronic device;
sending the locking commands to the electronic device to lock the electronic device when a signal of locking the electronic device is received by the communication device;
sending an unlocking command to the electronic device to unlock the electronic device when a signal of unlocking the electronic device is received by the communication device; and
terminating the control protocol between the communication device and the electronic device.

8. The method according to claim 7, wherein the control protocol comprises identification information of the communication device and identification information of the electronic device, and a communication mode between the communication device and the electronic device.

9. The method according to claim 7, further comprises:
receiving a feedback of whether to confirm or deny the establishment of the control protocol from the electronic device;
receiving a feedback of whether to confirm or deny the locking command from the electronic device; and
receiving a feedback of whether to confirm or deny the unlocking command from the electronic device.

10. The method according to claim 7, wherein each of the locking command comprises a locking target, a locking time period, and/or a command sending time.

11. The method according to claim 10, wherein the signal of locking the electronic device is received when the command sending time of the locking command reaches.

12. The method according to claim 10, wherein the signal of unlocking the electronic device is received when a preset unlocking option in the communication device is selected a, or the locking time period of the locking command expires, or the electronic device sends an unlocking request.

13. A non-transitory storage medium having stored thereon instructions that, when executed by processers of a communication device, causes the processers to perform a method of controlling locking or unlocking of an electronic device, wherein the method comprises:
establishing a control protocol between the communication device and the electronic device;
presetting locking commands of the electronic device;
sending the locking commands to the electronic device to lock the electronic device when a signal of locking the electronic device is received by the communication device;
sending an unlocking command to the electronic device to unlock the electronic device when a signal of unlocking the electronic device is received by the communication device; and
terminating the control protocol between the communication device and the electronic device.

14. The non-transitory storage medium according to claim 13, wherein the control protocol comprises identification information of the communication device and identification information of the electronic device, and a communication mode between the communication device and the electronic device.

15. The non-transitory storage medium according to claim 13, wherein the method further comprises:
receiving a feedback of whether to confirm or deny the establishment of the control protocol from the electronic device;
receiving a feedback of whether to confirm or deny the locking command from the electronic device; and
receiving a feedback of whether to confirm or deny the unlocking command from the electronic device.

16. The non-transitory storage medium according to claim 13, wherein each of the locking command comprises a locking target, a locking time period, and/or a command sending time.

17. The non-transitory storage medium according to claim 16, wherein the signal of locking the electronic device is received when the command sending time of the locking command reaches.

18. The non-transitory storage medium according to claim 16, wherein the signal of unlocking the electronic device is received when a preset unlocking option in the communication device is selected a, or the locking time period of the locking command expires, or the electronic device sends an unlocking request.
